(19) United States
(12) Patent Application Publication
(10) Pub. No.: US 2016/0264049 A1
(43) Pub. Date: Sep. 15, 2016

(54) DYNAMICALLY ADJUSTING SURVEILLANCE DEVICES

(71) Applicant: RAZMIK KARABED, SAN JOSE, CA (US)

(72) Inventor: RAZMIK KARABED, SAN JOSE, CA (US)

(21) Appl. No.: 14/677,839

(22) Filed: Apr. 2, 2015

Related U.S. Application Data
(60) Provisional application No. 62/132,384, filed on Mar. 12, 2015.

(51) Int. Cl. B60R 1/00; G06T 7/60; H04N 5/247; G06T 7/00; H04N 5/232; G06K 9/00; G06K 9/52

(52) U.S. Cl. CPC B60R 1/00; G06K 9/00771; G06T 7/60; G06K 9/52; G06T 7/0042; H04N 5/23238; H04N 5/247; G06K 9/00798; G06K 2009/4666

(57) ABSTRACT

A dynamically adjusting surveillance system provides a monitor on one or both sides of a vehicle, each monitor including one or more cameras capturing an image that includes a key region. The monitors can display this key region to a driver of the vehicle. The key region can be updated based on the activities of the driver. For example, the key region can change to provide a desirable view for the driver before, during and after a turn is made. An angular sensor can be used to detect the position of the vehicle in the turn to dynamically update the key region displayed to the driver. The key region can be changed at a sufficient frequency so that a gradual and smooth view is provided to the driver during the turn.

### RELATED APPLICATIONS

This application relates to, claims priority from, and incorporates herein by reference, as if fully set forth, the following:

1) U.S. Provisional Patent Application Ser. No. 62/132384 filed on Mar. 12, 2015 and entitled “Dynamically Adjusting Surveillance Devices”.

### BACKGROUND OF THE INVENTION

1. Field of the Invention

The invention relates generally to surveillance devices and methods, and more particularly to dynamically adjusting surveillance devices that can, for example, assist a driver when making a turn.

2. Description of Prior Art and Related Information

A large number of car crashes is due to a lack of adequate surveillance during turns at intersections. According to the U.S. Department of Transportation, National Highway Traffic Safety Administration (NHTSA), DOT HS 811 366, September 2010, entitled “Crash Factors in Intersection-Related Crashes: An On-Scene Perspective”, among 12 critical pre-crash events, a vehicle turning left at an intersection is number one, being present in 22.2% of all crashes. Inadequate surveillance is the number one driver attributed critical reason of intersection-related crashes.

Thus improving surveillance at intersections will reduce car crashes significantly. During turns, views provided by traditional car side mirrors are not towards directions that the car is the most vulnerable, as explained below.

The proper use of right-side and left-side mirrors is a necessary driving skill. These mirrors provide great help to a driver in making many important driving decisions. Nevertheless, during a typical left or right turn, except at the start and at the end of the turn, these mirrors provide views that, in general, are not the most helpful. A study of the following situations confirms the above assertion. There are four scenarios including A1) right side mirror during a left turn; A2) right-side mirror during a right turn; A3) left-side mirror during a left turn; and A4) left-side mirror during a right turn.

With respect to scenario A1 (right-side mirror during a left turn) and referring to FIG. 1, an automobile 4 is depicted in three positions: facing north at an intersection 5 (position 22), facing north-west in the intersection 5 (position 23), and facing west past the intersection 5 (position 24). The automobile 4 has a right-side mirror 1 and a left-side mirror 2. At the start of the turn, the mirrors 1, 2 are all showing views facing south. The right-side mirror 1 is showing a view south from the right side of the automobile 4, and the left-side mirror 2 is showing a view south from the left side of the automobile 4. At the end of the left turn, the mirrors 1, 2 are showing views facing east. However, during the left turn in the intersection 5, the mirrors 1, 2 are mostly showing views of the surroundings at the south/east corner of the intersection 5. In general, these views are not the most helpful. Views of the two streets would be more helpful since they would show nearby automobiles.

With respect to scenario A2 (right-side mirror during a right turn) and referring to FIG. 2, the automobile 4 is depicted again in three positions: facing north at the intersection 5 (position 22), facing north-east in the intersection 5 (position 25), and facing east past the intersection 5 (position 26). Again at the start of the turn, the mirrors 1, 2 are all showing views facing south. At the end of the right turn, the mirrors 1, 2 are showing views facing west. However, during the right turn in the intersection 5, the mirrors 1, 2 are mostly showing views of the surroundings at the south/west corner of the intersection 5. Again, in general, these views are not the most helpful since they show a portion of the street which carries cars going south, past the intersection 5.

With respect to scenario A3 (left-side mirror during a left turn), the analysis uses the same logic as scenario A2, except that the rotational polarities are reversed.

With respect to scenario A4 (left-side mirror during a right turn), the analysis uses the same logic as scenario A1, except that the rotational polarities are reversed.

Therefore, conventional side mirrors are not very helpful in providing surveillance during turns.

In conventional vehicle surveillance systems, to improve surveillance during turns, a sensor is used to measure the rotational position of the automobile. Position changes are then calculated by a controller and, based on the position changes, the mirrors are rotated to have views with more useful surveillance information.

In most conventional surveillance systems, more useful views include blind spots toward the side-rear of automobiles. More recently, a surveillance system for an automobile at an intersection is described that provides more useful views that include traffic in the crossing street. This is achieved by rotating the mirrors to adjust the view provided.

As a television screen looks big when viewed from the front and it looks small when viewed from an angle, the viewing window of a side mirror varies as it rotates. Therefore, for some rotational angles, the viewing window of a side mirror becomes very small. Of course this only happens when the angles are big; nevertheless, there are situations when such large angles are desired. Hence, a disadvantage of some conventional solutions is that for some desired large rotational angles, the viewing windows of the side mirrors are small.

Accordingly, a need exists to improve dynamically adjusted surveillance systems.

### SUMMARY OF THE INVENTION

In accordance with the present invention, structures and associated methods are disclosed which address these needs and overcome the deficiencies of the prior art.

US patent application no. 14536060, which is herein incorporated in its entirety by reference, offers the following solution to the issue of a significantly reduced viewing window. The mirror is replaced with a combination of a camera and a monitor, then, based on positional changes, the camera is dynamically rotated with a motor to capture useful views. The camera views are then displayed on the monitor without having to rotate the monitor and reduce its viewing window. The motor that rotates the camera is a major cost and a potential area for maintenance. Moreover, this conventional system uses an end switch and calibration process that is required with the motor driven camera.

Starting from U.S. patent application Ser. No. 14/536,060, the current application makes the following modifications to the dynamically adjustable surveillance device: The device that rotates the camera, which usually is a motor is eliminated, instead it is required for the camera to have a wide enough angle lens. For a given position of the automobile at an intersection only a portion of the camera view that is helpful is displayed on the monitor.

The advantages obtained over the conventional design include the following: 1) less cost. The device that rotates the camera in the conventional design is one of the major cost areas of the dynamically adjustable surveillance device; therefore the elimination of the device that rotates the camera lowers the overall cost. This elimination makes the end switch used in the calibration of the conventional device useless, therefore further reducing cost. 2) Improved durability. Since the device that rotates the camera is the major moving part of the conventional surveillance device, it is the most susceptible to wear and tear. 3) Improved viewing quality. By eliminating the device that rotates the camera, the mechanical vibration associated with the conventional device is also eliminated.

In a first aspect of the present invention, a dynamically adjusting surveillance system of a moving vehicle is disclosed. The system includes a camera configured for capturing a view that contains a key region encompassing a desired key view. An angular sensor is configured for detecting the orientation of a vehicle, where the angular sensor provides an angular position signal.

The system further includes a first processor and memory unit communicating with the angular sensor and with a turn signal switch of the vehicle, the first processor and memory unit receiving the angular position signal and a turn indication signal from the turn signal switch, the first processor and memory unit calculating the updated position of the key region based on the angular position signal and the turn indication signal, the first processor and memory unit providing an updated position of the key region to a display interface unit.

Based on the updated position of the key region from the first processor and memory unit, the display interface unit uses a second processor and memory unit to limit the view of the camera to the portion of the view encompassed by the updated key region. Further the display interface unit uses the second processor and memory unit to convert the limited view into a suitable signal to display on a monitor. The monitor provides a driver of the vehicle with a key desired field of view.

In a first exemplary embodiment, the key desired view typically includes a view of a road section immediately behind the vehicle before the turning is initiated. The key desired view typically includes a view of a road section opposite to that of the road section into which the vehicle is turning. The camera typically has a medium to wide angle lens.

In an exemplary embodiment, the system further includes a Global Positioning System (GPS) providing GPS signals to the first processor and memory unit.

The first processor and memory unit typically terminates the dynamically adjusting surveillance system based on information from the GPS.

The first processor and memory unit typically updates the position of the key region based on side information from the GPS.

In the second exemplary embodiment, a dynamically adjusting surveillance system of a moving vehicle is disclosed. The system includes cameras configured together to capture a wide, panorama view containing a key region that encompasses a desired key view and an angular sensor configured for detecting the orientation of a vehicle, where the angular sensor provides an angular position signal.

The system further includes a first processor and memory unit communicating with the angular sensor and a turn signal switch of the vehicle, the first processor and memory unit receiving the angular position signal and a turn indication signal from the turn signal switch, the first processor and memory unit calculating the updated position of the key region based on the angular position signal and the turn indication signal, the first processor and memory unit providing an updated position of the key region to a display interface unit.

Based on the updated position of the key region from the first processor and memory unit, the display interface unit uses a second processor and memory unit to limit the wide, panorama view of cameras to the portion of the view encompassed by the updated key region. Further, the display interface unit uses the second processor and memory unit to convert the limited view into a suitable signal to display on a monitor. The monitor provides a driver of the vehicle with a key desired field of view.

In one exemplary embodiment, the key desired view typically includes a view of a road section immediately behind the vehicle before the turning is initiated. The key desired view typically includes a view of a road section opposite to that of the road section into which the vehicle is turning.

Further, in some embodiments, two cameras are used to generate the wide, panorama view.

The system typically further includes a Global Positioning System (GPS) providing GPS signals to the first processor and memory unit.

The first processor and memory unit typically terminates the dynamically adjusting surveillance system based on information from the GPS.

The first processor and memory unit typically updates the position of the key region based on side information from the GPS.

These and other features and advantages of the invention will become more apparent with a description of preferred embodiments in reference to the associated drawings.

### BRIEF DESCRIPTION OF THE DRAWINGS

FIG. 1 illustrates an automobile making a left turn with a conventional automobile mirror;

FIG. 2 illustrates an automobile making a right turn with the conventional automobile mirror;

FIG. 3 is a block diagram description of a dynamically adjusting surveillance system according to exemplary embodiments of the present invention;

FIG. 4 illustrates a left side monitor and a camera with respect to an automobile;

FIG. 5 illustrates a right side monitor and a camera with respect to an automobile;

FIG. 6 illustrates a dynamically adjusting surveillance system used when making a left turn with a right side monitor and camera according to an exemplary embodiment of the present invention;

FIG. 7 illustrates a dynamically adjusting surveillance system used when making a left turn with a left side monitor and camera according to an exemplary embodiment of the present invention;

FIG. 8 illustrates a dynamically adjusting surveillance system used when making a right turn with a right side monitor and camera according to an exemplary embodiment of the present invention;

FIG. 9 illustrates a dynamically adjusting surveillance system used when making a right turn with a left side monitor and camera according to an exemplary embodiment of the present invention;

FIG. 10 illustrates a left side monitor and two cameras with respect to an automobile;

FIG. 11 illustrates a right side monitor and two cameras with respect to an automobile;

FIG. 12 is a block diagram description of the dynamically adjusting surveillance system of FIG. 10 and FIG. 11;

FIG. 13 illustrates a dynamically adjusting surveillance system used when making a left turn with a left side monitor and camera according to an exemplary embodiment of the present invention;

FIG. 14 illustrates a dynamically adjusting surveillance system used when making a left turn with a right side monitor and camera according to an exemplary embodiment of the present invention;

FIG. 15 illustrates a dynamically adjusting surveillance system used when making a right turn with a right side monitor and camera according to an exemplary embodiment of the present invention; and

FIG. 16 illustrates a dynamically adjusting surveillance system used when making a right turn with a left side monitor and camera according to an exemplary embodiment of the present invention.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention is described using various examples. Each example describes various situations and embodiments where the system of the present invention may be applied. The examples are used to describe specific incidents in which the present invention may be useful but is not meant to limit the present invention to such examples.

### EXAMPLE 1

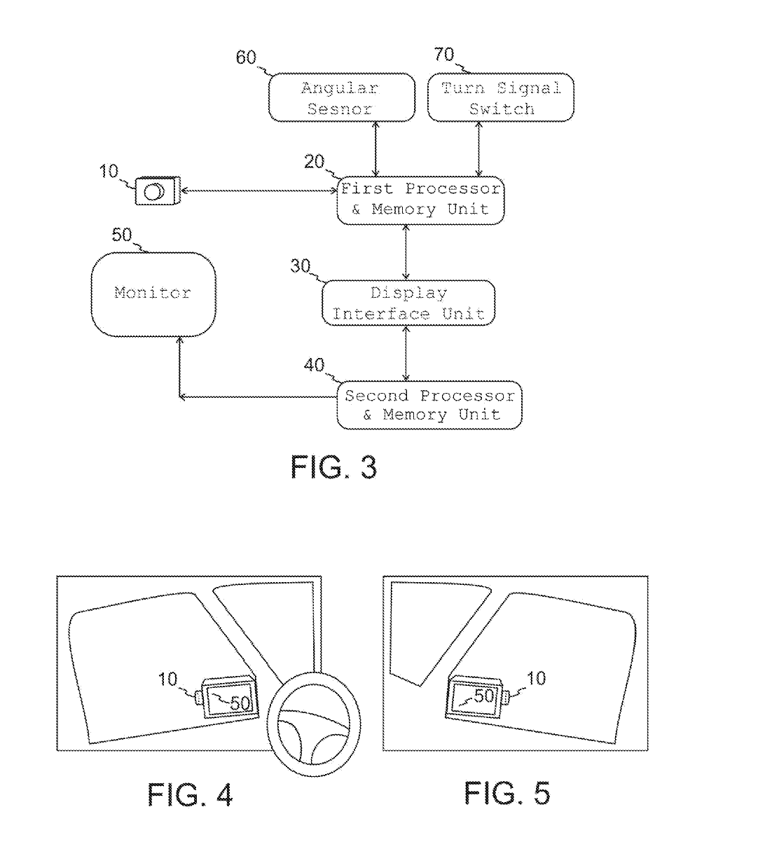

Example 1 is explained using FIGS. 3, 4, and 6. FIG. 3 gives a block diagram of a dynamically adjusting surveillance system. A camera 10 may be connected to a first processor and memory unit 20. The camera 10 may capture a view containing a key region containing a desired view. The camera 10 may send a wide view signal to the first processor and memory unit 20.

An angular sensor 60 may be connected to the first processor and memory unit 20. The angular sensor 60 may be configured to detect the angular orientation of a vehicle so that the angular sensor 60 provides an angular position signal to the first processor and memory unit 20.

A turn signal switch 70 may be connected to the first processor and memory unit 20. The turn signal switch 70 may send a turn indicating signal to the first processor and memory unit 20. The first processor and memory unit 20 may be connected to a display adaptor unit 30.

When the turn signal switch 70 is on its ‘OFF’ position a) the first processor and memory unit 20 may provide a key region position signal to the display interface unit 30; b) based on the view signal and the key region position signal, using a second processor and memory unit 40, the display adaptor unit 30 may generate a limited view signal that corresponds to the key region of the view signal of the camera 10; c) the display adaptor unit 30, further, using the second processor and memory unit 40, may convert the limited view signal into a suitable input signal to a monitor 50; and d) the monitor 50 may provide a driver of the vehicle with a desired view.

When the turn signal switch 70 is on its ‘ON’ position a) the first processor and memory unit 20 may calculate an updated position of the key region of the view signal of the camera 10 based on the angular position signal, then the first processor and memory unit 20 may provide an updated key region position signal to the display interface unit 30; b) based on the view signal and the updated key region position signal, using the second processor and memory unit 40, the display adaptor unit 30 may generate a limited view signal that corresponds to the updated key region of the view signal of the camera 10; c) the display adaptor unit 30, further, using the second processor and memory unit 40 may convert the limited view signal into a suitable input signal to a monitor 50; and d) the monitor 50 may provide a driver of the vehicle with a desired view.

In one application, when the turn signal switch 70 is on its ‘OFF’ position, the key region may be a view compatible to the view in a traditional side mirror, where the monitor 50 displays a view similar to the view in a traditional side mirror.

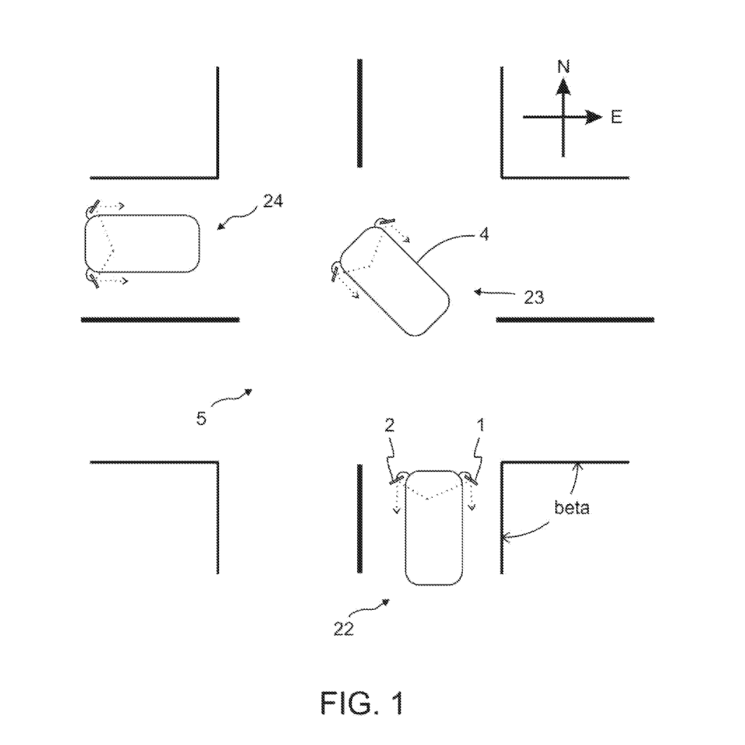

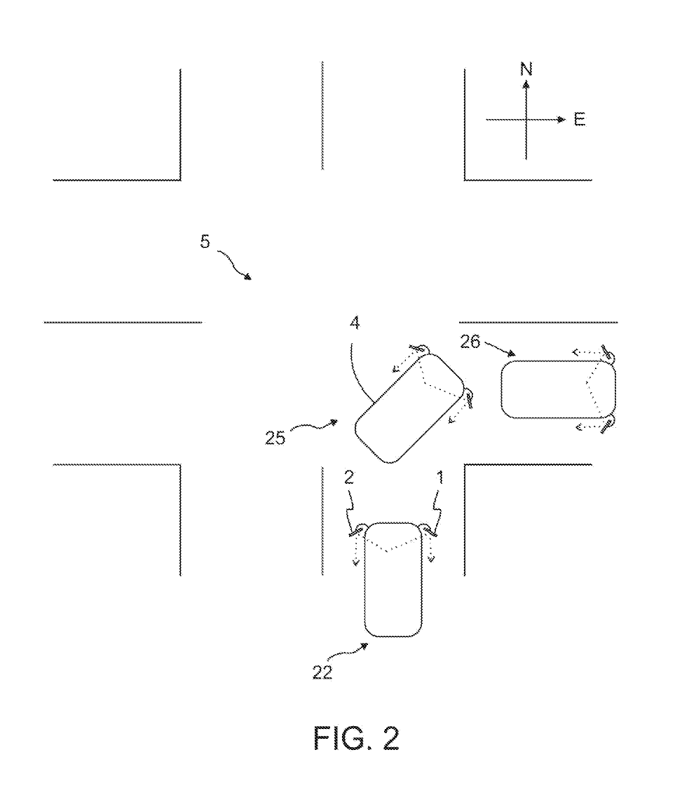

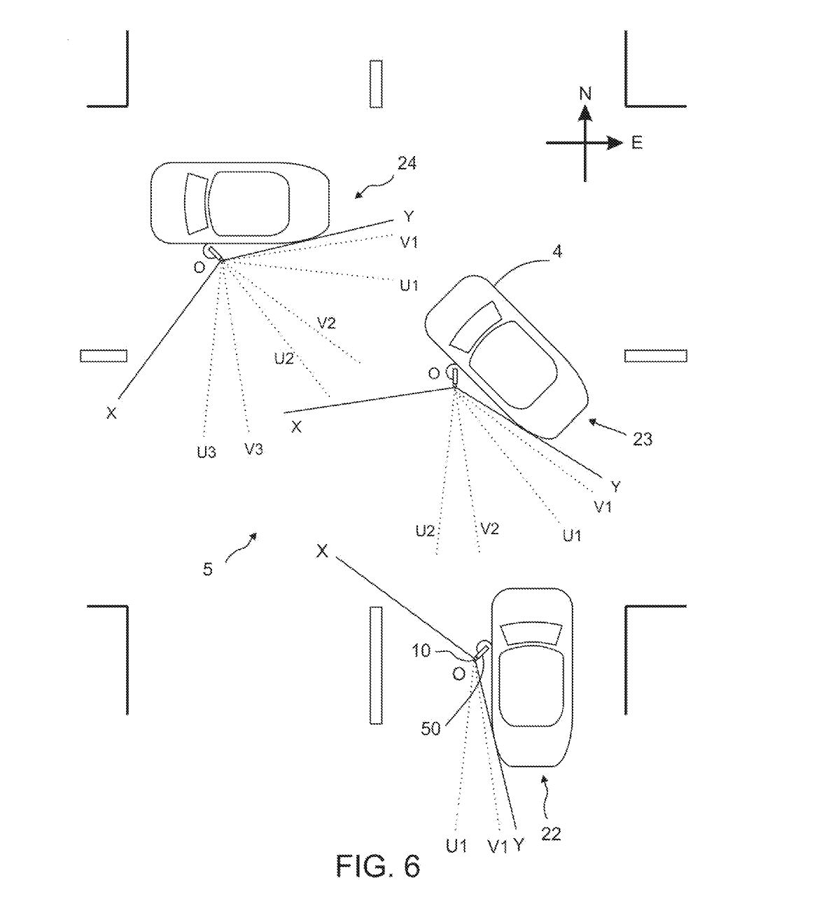

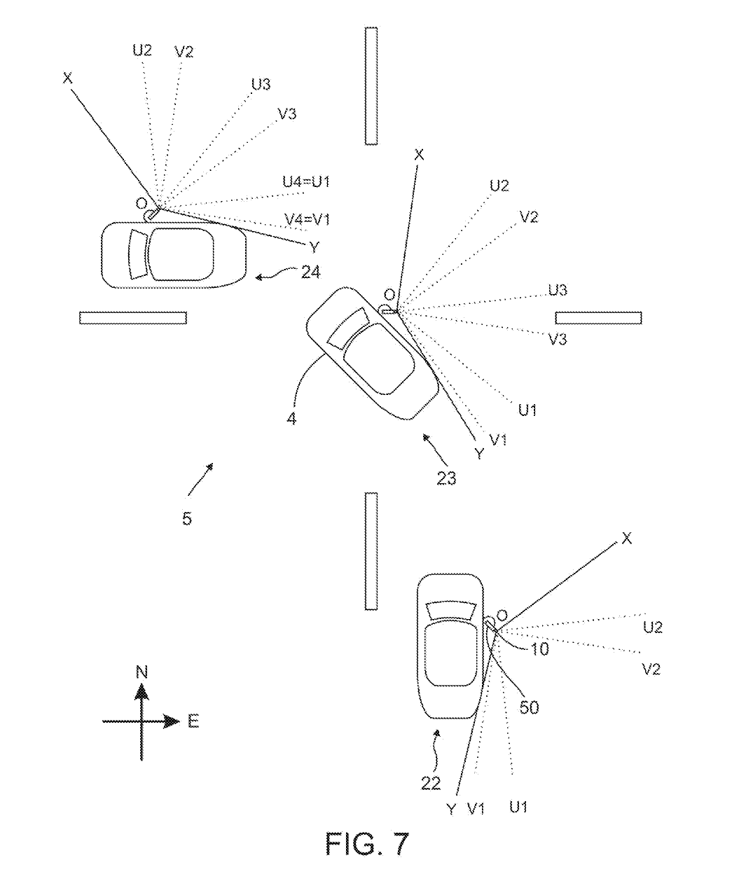

FIG. 4 depicts the monitor 50, and the camera 10 with respect to the automobile 4. Example 1 applies to the left side monitor during left turns. In FIG. 6, the automobile 4, the monitor 50 and the camera 10 are shown in the three positions 22, 23, and 24 of FIG.1.

At the position 22, facing north, the view signal of the camera 10 corresponds to a view spanning XOY angle, and the key region may be defined by an angle, V1OU1. The desired view is compatible to the view of a traditional left side mirror. While FIG. 6 shows a specific camera view XOY angle, this angle may vary depending on the capabilities of the camera 10. Typically, the XOY angle is a wide angle view. Often the XOY angle is a wide angle view spanning greater than 90 degrees, and even more often, spanning at least 120 degrees.

When the turn signal switch 70 is set to its ‘ON’ position, indicating a left turn (for example 1 ), the desired view may become a view of the road section immediately behind the vehicle on the left side before the turning is initiated. Until the left turn is completed, the desired view may stay the same, it faces south.

As the automobile 4 is turning left, the view in the display 50 may be of the road section facing south. At the end of the left turn, the view in the display 50 may return to a view compatible to the view of a traditional left side mirror.

More specifically, referring to FIG. 6, when the automobile 4 is in the position 23, having completed half of the left turn, the view of the camera 10 may correspond to the view spanning the XOY angle. Since the position of the camera 10 is stationary with respect to the automobile 4, the view of the camera 10 turns as the automobile 4 is turning. This explains why the XOY angle that corresponds to the view of the camera 10 at the position 23 is a rotated version of the XOY angle at the position 22. At the position 23, the key region may be defined by an angle, V2OU2, and the desired view may be toward the south, spanning the angle V2OU2.

When the automobile 4 is in the position 24, just before the left turn is completed, the view of the camera 10 continues to correspond to the view spanning the XOY angle. The key region may be defined by an angle, V3OU3, and the desired view may be toward the south, spanning an angle V3OU3.

Finally when the automobile 4 is in the position 24 and after the left turn is completed, the view of the camera 10 continues to correspond to the view spanning the XOY angle. The desired view may return to a view compatible to a view in a traditional left side mirror; it is toward the east, spanning the angle V1OU1. At this point the key region may be defined by the angle V1OU1.

In terms of the block diagram of FIG. 3, in all three positions 22, 23 and 24, the first processor and memory unit 20 may receive a view signal corresponding to the angle XOY. At the position 22, the first processor and memory unit 20 may communicate to the display interface unit 30 to use the V1OU1 angle as defining the key region. While at the position 23, the first processor and memory unit 20 may communicate to the display interface unit 30 to use the V2OU2 angle as defining the key region. Whereas at the position 24, the first processor and memory unit 20 may communicate to the display interface unit 30 to use the V3OU3 angle as defining the key region.

In turn, the display interface unit 30 may use the second processor and memory unit 40 to limit the view of the camera 10 to the portion of the view encompassed by the angle V1OU1 at the position 22. The display interface unit may use the second processor and memory unit 40 to limit the view of the camera 10 to the portion of the view encompassed by the angle V2OU2 at the position 23. Finally, the display interface unit 30 may use the second processor and memory unit 40 to limit the view of the camera 10 to the portion of the view encompassed by the angle V3OU3 at the position 24.

It should be noted that the key region position may be updated dynamically and gradually from V1OU1 to V2OU2 to V3OU3 as the automobile 4 is making the left turn. The updates may be such that while the view of the camera 10, angle XOY, is turning during the left turn in a counter clockwise direction, the key region may be defined by an angle facing south at all times during the left turn.

Properties that are used by the first processor and memory unit 20 to update the position of the key region are as follows. Once a left turn signal is detected, the angular position of the automobile 4 derived from the angular sensor 60 may be stored in the memory part of the first processor and memory unit 20. Then, during the left turn, between successive readings of the angular sensor 60, the change in the angular position of the automobile 4 may be calculated by the first processor and memory unit 20. In response to a change of delta degrees, the first processor and memory unit 20 may update the position of the key region as follows: angle VcOUc is angle VpOUp rotated by -delta degrees, where VpOUp is the angle corresponding to the position of the previous key region, VcOUc is the angle corresponding to the position of the current key region, and -delta degrees rotation is in the opposite of delta degrees rotation.

Therefore going back to FIG. 6, from the position 22 to position the 23, for example, the automobile 4 makes a total of 45 degrees rotation in a counter clockwise direction. Hence the key region is updated for a total of 45 degrees in a clockwise direction from the angle V1OU1 in the position 23 to the angle V2OU2 in the position 23.

Similarly from the position 23 to the position 24, the automobile 4 makes another total of 45 degrees rotation in a counter clockwise direction. Hence the key region is updated for another total of 45 degrees in a clockwise direction from the angle V2OU2 in the position 24 to the angle V3OU3 in the position 24.

Typically, all the updates are made gradually, making the view in the display 50 smooth.

For ease of illustration in the drawings, the key regions have a view of about 15 degrees for both the right and the left dynamically adjusting surveillance systems. A report titled “FIELD OF VIEW IN PASSENGER CAR MIRRORS” (Report No. UMTRI-2000-23, June 2000, Transportation Research Institute, the University of Michigan) states the average view for the left side mirror is 12.9 degrees. This number is the average of the angle over the set of automobiles they tested. The average for the right side mirror is stated as 22.5 degrees. The present invention may vary the key regions, for example, from about 10 to about 20 degrees, as may be optimal for a particular situation, vehicle or the like.

In the first processor and memory unit 20, the memory portion typically is used for storing a firmware for the processor. The memory portion may also be used for performing arithmetic operations and for storing results. In some architectures, the memory portion can hold the camera signal over a predetermined time period.

The same may be true for the second processor and memory unit 40. More and more, the processor in the first unit 20 and the processor in the second unit 40 are customized with different strengths. More specifically; the processor in the first unit 20 may be customized for complicated, long series of arithmetic operations in general, while the processor in the second unit 40 may be customized for limited complexity parallel arithmetic operations.

In some architectures, the second processor and memory unit 40 and the display interface unit 30 are combined into one block, which is denoted as a Graphics Processing Unit (GPU).

In more customized designs, the first processor and memory unit 20 and the second processor and memory unit 40 can refer to a single processor and memory unit. Further, in even more customized designs, the display interface unit 30 can be part of the first processor and memory unit 20.

### EXAMPLE 2

Example 2 is explained using FIGS. 3, 5, and 7. Example 2 uses the same block diagram, FIG. 3, as did Example 1 . Therefore, the earlier description of FIG. 3 still apply.

FIG. 5 depicts the monitor 50, and the camera 10 with respect to the automobile 4 according to Example 2 . Example 2 applies to the right side monitor during left turns. In FIG. 7, the automobile 4, the monitor 50 and the camera 10 are shown in the three positions 22, 23, and 24 of FIG.1.

At the position 22, facing north, before the turn signal switch 70 is set to its ‘ON’ position, the view signal of the camera 10 corresponds to a view spanning XOY angle, and the key region may be defined by an angle, V1OU1. The desired view is compatible to the view of a traditional right side mirror.

When the turn signal switch 70 is set to its ‘ON’ position, indicating a left turn (for Example 2 ), the desired view may change quickly to a view of a road section opposite to that of the road section into which the vehicle is turning. The key region may change from being defined by an angle, V1OU1 to being defined by an angle, V2OU2 at the position 22 of FIG. 7. The angle V2OU2 may be obtained by rotating the angle V1OU1 by a predetermined angle, alpha. Alpha may be equal to 90 degrees counter clockwise. Until the left turn is completed, the desired view stays the same, it faces east.

As the automobile 4 is turning left, the view in the display 50 may be of the road section facing east. At the end of the left turn, the view in the display 50 may return to a view compatible to the view of a traditional right side mirror.

More specifically, referring to FIG. 7, when the automobile 4 is in the position 23, having completed half of the left turn, the view of the camera 10 corresponds to the view spanning the XOY angle. Since the position of the camera 10 is stationary with respect to the automobile 4, the view of the camera 10 turns as the automobile 4 is turning. This explains why the XOY angle that corresponds to the view of the camera 10 at the position 23 is a rotated version of the XOY angle at the position 22. At the position 23, the key region may be defined by an angle, V3OU3, and the desired view is toward the east, spanning the angle V3OU3.

When the automobile 4 is in the position 24, just before the left turn is completed, the view of the camera 10 corresponds to the view spanning the XOY angle. The key region may be defined by an angle, V4OU4, and the desired view is toward the east, spanning an angle V4OU4.

Finally when the automobile 4 is in the position 24 and after the left turn is completed, the view of the camera 10 corresponds to the view spanning the XOY angle. The desired view may return to a view compatible to a view in a traditional right side mirror; it is toward the east, spanning the angle V1OU1. At this point, the key region may once again be defined by the angle V1OU1.

In terms of the block diagram of FIG. 3, in all three positions: 22, 23 and 24, the first processor and memory unit 20 may receive a view signal corresponding to the angle XOY. At the position 22, after the turn signal switch 70 is set to its ‘ON’ position, the first processor and memory unit 20 may communicate to the display interface unit 30 to use the V2OU2 angle as defining the key region. While at the position 23, the first processor and memory unit 20 may communicate to the display interface unit 30 to use the V3OU3 angle as defining the key region. Whereas at the position 24, the first processor and memory unit 20 may communicate to the display interface unit 30 to use the V4OU4 angle as defining the key region.

In turn, the display interface unit 30 may use the second processor and memory unit 40 to limit the view of the camera 10 to the portion of the view encompassed by the angle V2OU2 at the position 22. The display interface unit 30 may use the second processor and memory unit 40 to limit the view of the camera 10 to the portion of the view encompassed by the angle V3OU3 at the position 23. Finally, the display interface unit 30 may use the second processor and memory unit 40 to limit the view of the camera 10 to the portion of the view encompassed by the angle V4OU4 at the position 24.

It should be noted that the key region position may change quickly from V1OU1 to V2OU2 in the position 22. Then, the key region position may be updated dynamically and gradually from V2OU2 to V3OU3 to V4OU4 as the automobile 4 is making the left turn. The updates may be such that while the view of the camera 10, angle XOY, is turning during the left turn in a counter clockwise direction, the key region may be defined by an angle facing east at all times during the left turn.

Properties that are used by the first processor and memory unit 20 to update the position of the key region are as follows. Once a left turn signal is detected, the angular position of the automobile 4 derived from the angular sensor 60 may be stored in the memory part of the first processor and memory unit 20. Then, during the left turn, between successive readings of the angular sensor 60, the change in the angular position of the automobile 4 may be calculated by the first processor and memory unit 20. In response to a change of delta degrees, the first processor and memory unit 20 may update the position of the key region as follows: angle VcOUc is angle VpOUp rotated by -delta degrees, where VpOUp is the angle corresponding to the position of the previous key region, VcOUc is the angle corresponding to the position of the current key region.

Therefore going back to FIG. 7, from the position 22 to position the 23, the automobile 4 may make a total of 45 degrees rotation in a counter clockwise direction. Hence the key region may be updated for a total of 45 degrees in a clockwise direction from the angle V2OU2 in the position 23 to the angle V3OU3 in the position 23.

Similarly from the position 23 to the position 24, the automobile 4 may make another total of 45 degrees rotation in a counter clockwise direction. Hence the key region may be updated for another total of 45 degrees in a clockwise direction from the angle V3OU3 in the position 24 to the angle V4OU4 in the position 24.

Typically, all the updates may be made gradually, making the view in the display 50 smooth.

### EXAMPLE 3

Example 3 is explained using FIGS. 3, 5, and 8. Example 3 uses the same block diagram, FIG. 3, as did Examples 1 and 2.

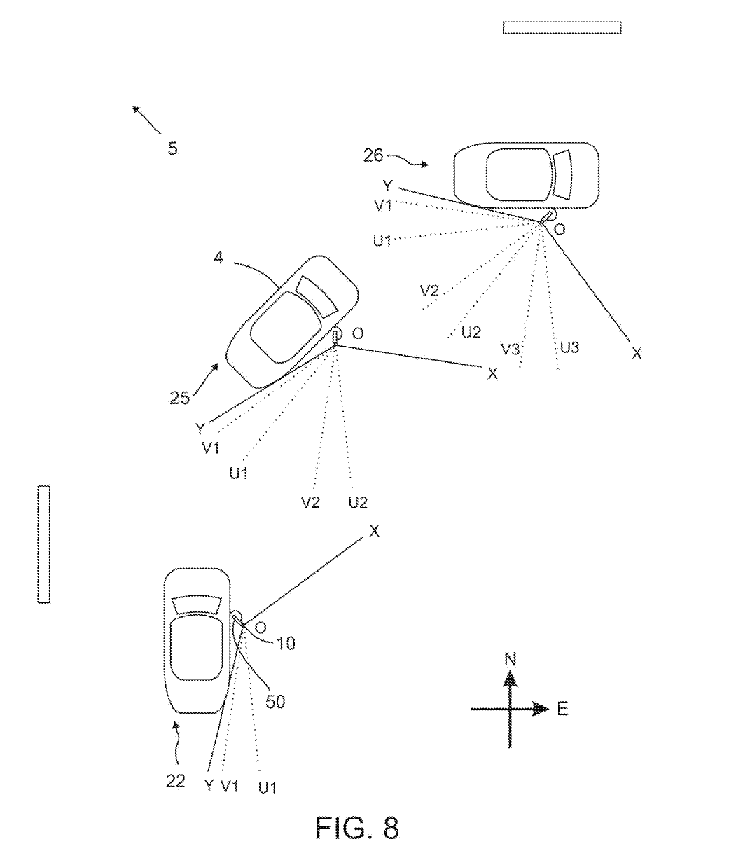

FIG. 5 depicts the monitor 50, and the camera 10 with respect to the automobile 4 according to Example 3 . Example 3 applies to the right side monitor during right turns. In FIG. 8, the automobile 4, the monitor 50 and the camera 10 are shown in the three positions 22, 25, and 26 of FIG. 1.

At the position 22, facing north, the view signal of the camera 10 corresponds to a view spanning the XOY angle, and the key region may be defined by an angle, V1OU1. The desired view is compatible to the view of a traditional right side mirror.

When the turn signal switch 70 is set to its ‘ON’ position, indicating a right turn (for Example 3 ), the desired view may become a view of the road section immediately behind the vehicle on the right side before the turn is initiated. Until the right turn is completed, the desired view may stay the same, it faces south.

As the automobile 4 is turning right, the view in the display 50 may be of the road section facing south. At the end of the right turn, the view in the display 50 may return to a view compatible to the view of a traditional right side mirror.

More specifically, referring to FIG. 8, when the automobile 4 is in the position 25, having completed half of the right turn, the view of the camera 10 corresponds to the view spanning the XOY angle. Since the position of the camera 10 is stationary with respect to the automobile 4, the view of the camera 10 turns as the automobile 4 is turning. This explains why the XOY angle that corresponds to the view of the camera 10 at the position 25 is a rotated version of the XOY angle at the position 22. At the position 25, the key region may be defined by an angle, V2OU2, and the desired view may be toward the south, spanning the angle V2OU2.

When the automobile 4 is in the position 26, just before the right turn is completed, the view of the camera 10 corresponds to the view spanning the XOY angle. The key region may defined by an angle, V3OU3, and the desired view may be toward the south, spanning an angle V3OU3.

Finally, when the automobile 4 is in the position 26 and after the right turn is completed, the view of the camera 10 corresponds to the view spanning the XOY angle. The desired view may return to a view compatible to a view in a traditional right side mirror; it is toward the west, spanning the angle V1OU1. At this point, the key region may again be defined by the angle V1OU1.

In terms of the block diagram of FIG. 3, in all three positions: 22, 25 and 26, the first processor and memory unit 20 may receive a view signal corresponding to the angle XOY. At the position 22, the first processor and memory unit 20 may communicate to the display interface unit 30 to use the V1OU1 angle as defining the key region. While at the position 25, the first processor and memory unit 20 may communicate to the display interface unit 30 to use the V2OU2 angle as defining the key region. Whereas at the position 26, the first processor and memory unit 20 may communicate to the display interface unit 30 to use the V3OU3 angle as defining the key region.

In turn, the display interface unit 30 may use the second processor and memory unit 40 to limit the view of the camera 10 to the portion of the view encompassed by the angle V1OU1 at the position 22. The display interface unit 30 may use the second processor and memory unit 40 to limit the view of the camera 10 to the portion of the view encompassed by the angle V2OU2 at the position 25. Finally, the display interface unit 30 may use the second processor and memory unit 40 to limit the view of the camera 10 to the portion of the view encompassed by the angle V3OU3 at the position 26.

It should be noted that the key region position may be updated dynamically and gradually from V1OU1 to V2OU2 to V3OU3 as the automobile 4 is making the right turn. The updates may be such that while the view of the camera 10, angle XOY, is turning during the right turn in a clockwise direction, the key region may be defined by an angle facing south at all times during the right turn.

Properties that are used by the first processor and memory unit 20 to update the position of the key region are as follows. Once a right turn signal is detected, the angular position of the automobile 4 derived from the angular sensor 60, may be stored in the memory part of the first processor and memory unit 20. Then, during the right turn, between successive readings of the angular sensor 60, the change in the angular position of the automobile 4 may be calculated by the first processor and memory unit 20. In response to a change of delta degrees, the first processor and memory unit 20 may update the position of the key region as follows: angle VcOUc is angle VpOUp rotated by -delta degrees, where VpOUp is the angle corresponding to the position of the previous key region, VcOUc is the angle corresponding to the position of the current key region, and -delta degrees rotation is in the opposite of delta degrees rotation.

Therefore, going back to FIG. 8, from the position 22 to position the 25, the automobile 4 may make a total of 45 degrees rotation in a clockwise direction, hence the key region may be updated for a total of 45 degrees in a counter clockwise direction from the angle V1OU1 in the position 25 to the angle V2OU2 in the position 25.

Similarly from the position 25 to the position 26, the automobile 4 may make another total of 45 degrees rotation in a clockwise direction, hence the key region may be updated for another total of 45 degrees in a counter clockwise direction from the angle V2OU2 in the position 26 to the angle V3OU3 in the position 26.

Typically, all the updates may be made gradually making the view in the display 50 smooth.

### EXAMPLE 4

Example 4 is explained using FIGS. 3, 4, and 9. Example 4 uses the same block diagram, FIG. 3, as did Examples 1-3. Therefore, the earlier description of FIG. 3 still applies.

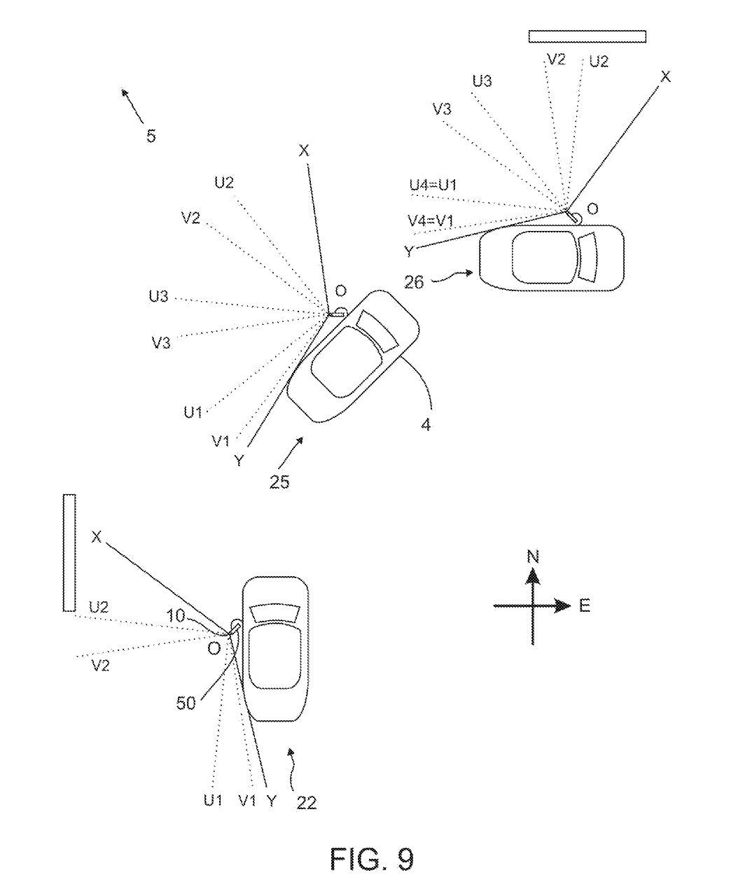

FIG. 4 depicts the monitor 50, and the camera 10 with respect to the automobile 4 according to Example 4 . Example 4 applies to the left side monitor during right turns. In FIG. 9, the automobile 4, the monitor 50 and the camera 10 are shown in the three positions 22, 25, and 26 of FIG.1.

At the position 22, facing north, before the turn signal switch 70 is set to its ‘ON’ position, the view signal of the camera 10 corresponds to a view spanning XOY angle, and the key region may be defined by an angle, V1OU1. The desired view may be compatible to the view of a traditional left side mirror.

When the turn signal switch 70 is set to its ‘ON’ position, indicating a right turn (for Example 4 ), the desired view may change quickly to a view of a road section opposite to that of the road section into which the vehicle is turning. The key region may change from being defined by an angle, V1OU1 to being defined by an angle, V2OU2 at the position 22 of FIG. 9. The angle V2OU2 may be obtained by rotating the angle V1OU1 by a predetermined angle, alpha. Alpha may be equal to 90 degrees clockwise. Until the right turn is completed, the desired view may stay the same, it faces west.

As the automobile 4 is turning right, the view in the display 50 may be of the road section facing west. At the end of the right turn, the view in the display 50 may return to a view compatible to the view of a traditional left side mirror.

More specifically, referring to FIG. 9, when the automobile 4 is in the position 25, having completed half of the right turn, the view of the camera 10 corresponds to the view spanning the XOY angle. Since the position of the camera 10 is stationary with respect to the automobile 4, the view of the camera 10 turns as the automobile 4 is turning. This explains why the XOY angle that corresponds to the view of the camera 10 at the position 25 is a rotated version of the XOY angle at the position 22. At the position 25, the key region may be defined by an angle, V3OU3, and the desired view may be toward the west, spanning the angle V3OU3.

When the automobile 4 is in the position 26 just before the right turn is completed, the view of the camera 10 corresponds to the view spanning the XOY angle. The key region may be defined by an angle, V4OU4, and the desired view may be toward the west, spanning an angle V4OU4.

Finally, when the automobile 4 is in the position 26 and after the right turn is completed, the view of the camera 10 corresponds to the view spanning the XOY angle. The desired view may return to a view compatible to a view in a traditional left side mirror; it is toward the west, spanning the angle V1OU1. At this point, the key region may again be defined by the angle V1OU1.

In terms of the block diagram of FIG. 3, in all three positions: 22, 25 and 26, the first processor and memory unit 20 may receive a view signal corresponding to the angle XOY. At the position 22, after the turn signal switch 70 is set to its ‘ON’ position, the first processor and memory unit 20 may communicate to the display interface unit 30 to use the V2OU2 angle as defining the key region. While at the position 25, the first processor and memory unit 20 may communicate to the display interface unit 30 to use the V3OU3 angle as defining the key region. Whereas at the position 26, the first processor and memory unit 20 may communicate to the display interface unit 30 to use the V4OU4 angle as defining the key region.

In turn, the display interface unit 30 may use the second processor and memory unit 40 to limit the view of the camera 10 to the portion of the view encompassed by the angle V2OU2 at the position 22. The display interface unit may use the second processor and memory unit 40 to limit the view of the camera 10 to the portion of the view encompassed by the angle V3OU3 at the position 25. Finally, the display interface unit 30 may use the second processor and memory unit 40 to limit the view of the camera 10 to the portion of the view encompassed by the angle V4OU4 at the position 26.

It should be noted that the key region position may change quickly from V1OU1 to V2OU2 in the position 22. Then, the key region position may be updated dynamically and gradually from V2OU2 to V3OU3 to V4OU4 as the automobile 4 is making the right turn. The updates may be such that while the view of the camera 10, angle XOY, is turning during the right turn in a clockwise direction, the key region may be defined by an angle facing west at all times during the right turn.

Properties that are used by the first processor and memory unit 20 to update the position of the key region are as follows. Once a right turn signal is detected, the angular position of the automobile 4 derived from the angular sensor 60 may be stored in the memory part of the first processor and memory unit 20. Then, during the right turn, between successive readings of the angular sensor 60, the change in the angular position of the automobile 4 may be calculated by the first processor and memory unit 20. In response to a change of delta degrees, the first processor and memory unit 20 may update the position of the key region as follows: angle VcOUc is angle VpOUp rotated by -delta degrees, where VpOUp is the angle corresponding to the position of the previous key region, VcOUc is the angle corresponding to the position of the current key region.

Therefore, going back to FIG. 9, from the position 22 to position the 25, the automobile 4 may make a total of 45 degrees rotation in a clockwise direction. Hence the key region may be updated for a total of 45 degrees in a counter clockwise direction from the angle V2OU2 in the position 25 to the angle V3OU3 in the position 25.

Similarly from the position 25 to the position 26, the automobile 4 may make another total of 45 degrees rotation in a clockwise direction. Hence the key region may be updated for another total of 45 degrees in a counter clockwise direction from the angle V3OU3 in the position 26 to the angle V4OU4 in the position 26.

Typically, all the updates may be made gradually making the view in the display 50 smooth.

### EXAMPLE 5

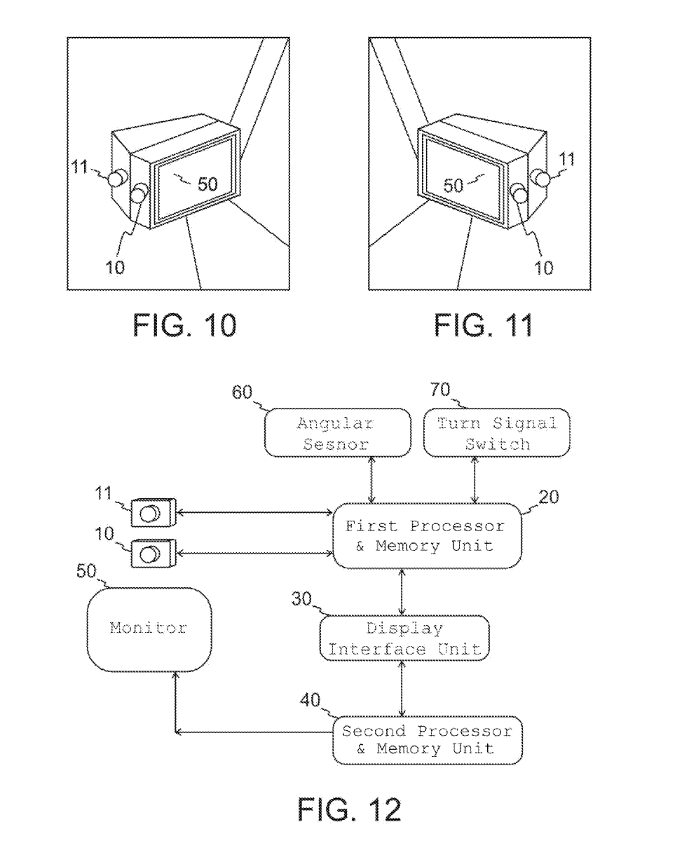

Example 5 is explained using FIGS. 12, 10, and 13. In this example, instead of one camera, more than one camera may be used. More specifically, referring to FIG. 10, the monitor 50, and two cameras, a first camera 11 and a second camera 12, with respect to the automobile 4, are depicted. The first and second cameras 11, 12 may be configured together to capture a wide, panorama view containing a key region containing a desired view. Each camera may provide a portion of the wide panorama view. Typically these portions overlap to make “stitching” them cleaner and easier. FIG. 12 gives a block diagram of a dynamically adjusting surveillance system.

The first camera 11 and the second camera 12 may be connected to the first processor and memory unit 20. The first and second cameras 11, 12 individually send a view signal to the first processor and memory unit 20; these view signals may be such that, together, they comprise a wide, panorama view containing a key region containing a desired view. The angular sensor 60 may be connected to the first processor and memory unit 20. The angular sensor 60 may be configured to detect the angular orientation of a vehicle, the angular sensor providing an angular position signal to the first processor and memory unit 20.

The turn signal switch 70 may be connected to the first processor and memory unit 20. The turn signal switch 70 may send a turn indicating signal to the first processor and memory unit 20. The first processor and memory unit 20 may be connected to the display adaptor unit 30.

When the turn indicating signal switch is on its ‘OFF’ position, a) the first processor and memory unit 20 may provide a key region position signal to the display interface unit 30; b) based on the view signals from the first and second cameras 11, 12, and the key region position signal, using the second processor and memory unit 40, the display adaptor unit 30 may generate a limited view signal that corresponds to the key region of the wide panorama view of the first and second cameras 11, 12; c) the display adaptor unit 30, further, using the second processor and memory unit 40 may convert the limited view signal into a suitable input signal to the monitor 50; and d) the monitor 50 may provide a driver of the vehicle with a desired view.

When the turn indicating signal switch is on its ‘ON’ position, a) the first processor and memory unit 20 may calculate an updated position of the key region of the wide panorama view of the first and second cameras 11, 12 based on the angular position signal, then the first processor and memory unit 20 may provide an updated key region position signal to the display interface unit 30; b) based on the view signals from the first and second cameras 11, 12, and the updated key region position signal, using the second processor and memory unit 40, the display adaptor unit 30 may generate a limited view signal that corresponds to the key region of the wide panorama view of the first and second cameras 11, 12; c) the display adaptor unit 30, further, using the second processor and memory unit 40 may convert the limited view signal into a suitable input signal to a monitor 50; and d) the monitor 50 may provide a driver of the vehicle with a desired view.

In one application, when the turn indicating signal is on its ‘OFF’ position, the key region may encompass a view compatible to the view in a traditional side mirror and the monitor 50 may display a view similar to the view in a traditional side mirror.

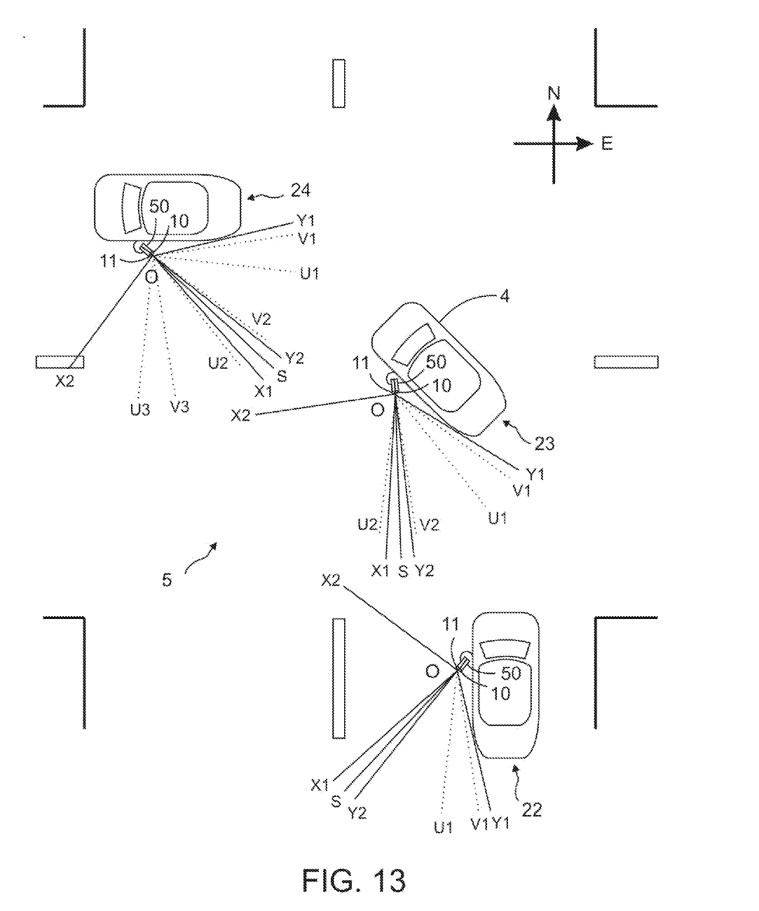

Example 5 applies to the left side monitor during left turns. In FIG. 13, the automobile 4, the monitor 50 and the first and second cameras 11, 12 are shown in the three positions 22, 23, and 24 of FIG.1.

At the position 22, facing north, before the turn signal switch 70 is set to its ‘ON’ position, the view signal of the first camera 11 corresponds to a view spanning X1OY1 angle, and the view signal of the camera 12 corresponds to a view spanning X2OY2 angle. These views overlap over the X1OY2 angle. Further, the wide panorama view of the first and second cameras 11, 12 corresponds to a view spanning X2OY1 angle. The key region may be defined by an angle V1OU1. The desired view may be compatible to the view of a traditional left side mirror.

When the turn signal switch 70 is set to its ‘ON’ position, indicating a left turn (for Example 5 ), the desired view may become a view of the road section immediately behind the vehicle on the left side before the turning is initiated. Until the left turn is completed, the desired view may stay the same, it faces south.

As the automobile 4 is turning left, the view in the monitor 50 may be of the road section facing south. At the end of the left turn, the view in the monitor 50 may return to a view compatible to the view of a traditional left side mirror.

More specifically, referring to FIG. 13, when the automobile 4 is in the position 23 having completed half of the left turn, the wide panorama view of the first and second cameras 11, 12 may correspond to a view spanning X2OY1 angle.

Since the position of the first and second cameras 11, 12 are stationary with respect to the automobile 4, the views of the first and second cameras 11, 12 turn as the automobile 4 is turning. This explains why the X2OY1 angle that corresponds to the wide panorama view of the first and second camera 11, 12 at the position 23 is a rotated version of the X2OY1 angle at the position 22.

At the position 23, the key region may be defined by an angle, V2OU2, and the desired view may be toward the south, spanning the angle V2OU2.

When the automobile 4 is in the position 24 just before the left turn is completed, the wide panorama view of the first and second cameras 11, 12 may correspond to the view spanning the X2OY1 angle. The key region may be defined by an angle, V3OU3, and the desired view may be toward south, spanning an angle V3OU3.

Finally, when the automobile 4 is in the position 24 and after the left turn is completed, the wide panorama view of the first and second cameras 11, 12 may correspond to the view spanning the X2OY1 angle. The desired view may return to a view compatible to a view in a traditional left side mirror; it is toward the east, spanning the angle V1OU1. At this point, the key region may again be defined by the angle V1OU1.

In terms of the block diagram of FIG. 12, in all three positions 22, 23 and 24, the first processor and memory unit 20 may receive the view signals corresponding to the angle X2OY1. At the position 22, the first processor and memory unit 20 may communicate to the display interface unit 30 to use the V1OU1 angle as defining the key region.

While at the position 23, the first processor and memory unit 20 may communicate to the display interface unit 30 to use the V2OU2 angle as defining the key region. Whereas, at the position 24, the first processor and memory unit 20 may communicate to the display interface unit 30 to use the V3OU3 angle as defining the key region.

For this example, as compared to Example 1 , the display interface unit 30 may have an additional task. The display interface unit 30 needs to handle situations when the key region does not entirely fall inside the view of one of the cameras. That is, the key region does not entirely fall inside X1OY1 angle and it does not entirely fall inside X2OY2 angle. For example, in FIG. 13, at the position 23, the key region angle U2OV2 does not fall inside X1OY1 or X2OY2. In this case, referring to FIG. 13 and the position 23, the display interface unit 30 needs to (1) find an angle V2OS, corresponding to a portion of the key region which is inside X1OY1; (2) find an angle SOU2, corresponding to the remaining portion of the key region inside X2OY2; (3) use the second processor and memory unit 40 to limit the view of the first camera 11 to the portion of the view encompassed by the angle V2OS; (4) use the second processor and memory unit 40 to limit the view of the second camera 12 to the portion of the view encompassed by the angle SOU2; and (5) stich the two limited views to form a limit view corresponding to the key region, angle V2OU2.

Above line OS is a ray inside X1OY2. Ray OS can be fixed with respect to X1OY2 for all angular positions of the automobile 4, or it can vary from angular position to angular position, as long as it is inside X1OY2.

In general, the display interface unit 30 may use the second processor and memory unit 40 to limit the wide panorama view of the first and second cameras 11, 12 to the key region, VOU angle. If the angle VOU entirely falls inside X1OY1, only the view of the first camera 11 can be used for this step. If angle VOU entirely falls inside X2OY2, only the view of the second camera 12 can be used for this step. Otherwise the above method can be used.

More specifically, referring to FIG. 13, the display interface unit 30 may use the second processor and memory unit 40 to limit the wide panorama view of the first and second cameras 11, 12 to the portion of the view encompassed by the angle V1OU1 at the position 22. Here, the key region entirely falls inside X1OY1, therefore only the view of the first camera 11 is used for this step.

The display interface unit 30 may use the second processor and memory unit 40 to limit the wide panorama view of the first and second cameras 11, 12 to the portion of the view encompassed by the angle V2OU2 at the position 23. Here, the key region does not entirely falls inside X1OY1 or X2OY2, therefore the above method is used for this step.

Finally, the display interface unit 30 may use the second processor and memory unit 40 to limit the wide panorama view of the first and second cameras 11, 12 to the portion of the view encompassed by the angle V3OU3 at the position 24. Here, the key region entirely falls inside X2OY2, therefore only the view of the second camera 12 is used for this step.

It should be noted that the key region position may be updated dynamically and gradually from V1OU1 to V2OU2 to V3OU3 as the automobile 4 is making the left turn. The updates may be such that while the wide panorama view of the first and second cameras 11, 12, the angle X2OY1 is turning during the left turn in a counter clockwise direction, the key region may be defined by an angle facing south at all times during the left turn.

Properties that are used by the first processor and memory unit 20 to update the position of the key region are as follows. Once a left turn signal is detected, the angular position of the automobile 4 derived from the angular sensor 60 may be stored in the memory part of the first processor and memory unit 20. Then, during the left turn, between successive readings of the angular sensor 60, the change in the angular position of the automobile 4 may be calculated by the first processor and memory unit 20. In response to a change of delta degrees, the first processor and memory unit 20 may update the position of the key region as follows: angle VcOUc is angle VpOUp rotated by -delta degrees, where VpOUp is the angle corresponding to the position of the previous key region, VcOUc is the angle corresponding to the position of the current key region, and - delta degrees rotation is in the opposite of delta degrees rotation.

Therefore, going back to FIG. 13, from the position 22 to position the 23, the automobile 4 may make a total of 45 degrees rotation in a counter clockwise direction. Hence the key region may be updated for a total of 45 degrees in a clockwise direction from the angle V1OU1 in the position 23 to the angle V2OU2 in the position 23.

Similarly, from the position 23 to the position 24, the automobile 4 may make another total of 45 degrees rotation in a counter clockwise direction. Hence the key region may be updated for another total of 45 degrees in a clockwise direction from the angle V2OU2 in the position 24 to the angle V3OU3 in the position 24. Typically, all the updates may be made gradually making the view in the monitor 50 smooth.

If the overlapping angle, X1OY2, between X1OY1 and X2OY2 is larger than the angle required to capture key regions, then no stitching method is needed since the key region would fall either inside the view of the first camera 11 or inside the view of the second camera 12. Therefore the display interface unit 30 can use the view signal of the camera 11 or the view signal of the camera 12 to perform the limiting process.

### EXAMPLE 6

Example 6 is explained using FIGS. 12, 11, and 14. Example 6 uses the same block diagram, FIG. 12, as did Example 5 . Therefore, the earlier description of FIG. 12 still applies.

In this example, more than one camera is used. More specifically, referring to FIG. 11, the monitor 50, and two cameras, the first camera 11 and the second camera 12, with respect to the automobile 4 are depicted. The first and second cameras 11, 12 may be configured together to capture a wide, panorama view containing a key region containing a desired view. Each camera may provide a portion of the wide panorama view. Typically these portions overlap to make “stitching” them cleaner and easier.

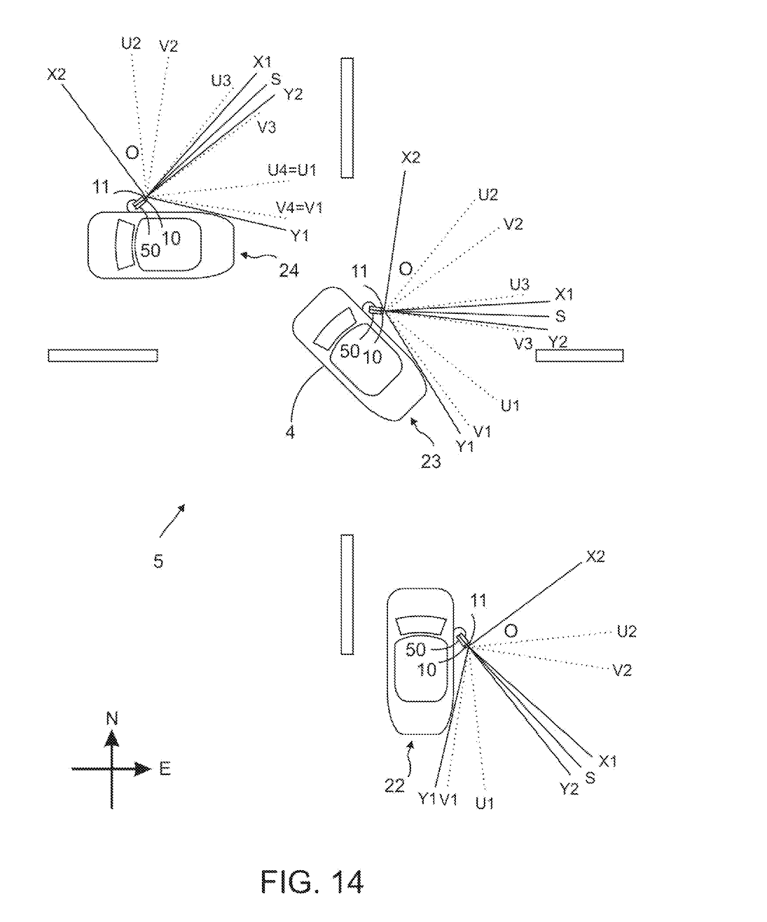

Example 6 applies to the right side monitor during left turns. In FIG. 14, the automobile 4, the monitor 50 and the first and second cameras 11, 12 are shown in the three positions 22, 23, and 24 of FIG.1.

At the position 22, facing north, before the turn signal switch 70 is set to its ‘ON’ position, the view signal of the first camera 11 may correspond to a view spanning X1OY1 angle, and the view signal of the second camera 12 may correspond to a view spanning X2OY2 angle. These views overlap over the X1OY2 angle. Further, the wide panorama view of the first and second cameras 11, 12 may correspond to a view spanning the X2OY1 angle. The key region may be defined by an angle V1OU1. The desired view may be compatible to the view of a traditional left side mirror.

When the turn signal switch 70 is set to its ‘ON’ position indicating a left turn (for Example 6 ), the desired view may change quickly to a view of a road section opposite to that of the road section into which the vehicle is turning. The key region may change from being defined by an angle, V1OU1 to being defined by an angle, V2OU2 in the position 22 of FIG. 14. The angle V2OU2 may be obtained by rotating the angle V1OU1 by a predetermined angle, alpha. Alpha may be equal to 90 degrees counter clockwise. Until the left turn is completed, the desired view may stay the same, it faces east.

As the automobile 4 is turning left, the view in the monitor 50 may be of the road section facing east. At the end of the left turn, the view in the monitor 50 may return to a view compatible to the view of a traditional right side mirror.

More specifically, referring to FIG. 14, when the automobile 4 is in the position 23 having completed half of the left turn, the wide panorama view of the first and second cameras 11, 12 may correspond to a view spanning X2OY1 angle.

Since the position of the first and second cameras 11, 12 are stationary with respect to the automobile 4, the views of the first and second cameras 11, 12 turn as the automobile 4 is turning. This explains why the X2OY1 angle that corresponds to the wide panorama view of the first and second cameras 11, 12 at the position 23 is a rotated version of the X2OY1 angle at the position 22.

At the position 23, the key region may be defined by an angle, V3OU3, and the desired view may be toward the east, spanning the angle V3OU3.

When the automobile 4 is in the position 24 just before the left turn is completed, the wide panorama view of the first and second cameras 11, 12 corresponds to the view spanning the X2OY1 angle. The key region may be defined by an angle, V4OU4, and the desired view may be toward the east, spanning an angle V4OU4.

Finally, when the automobile 4 is in the position 24 and after the left turn is completed, the wide panorama view of the first and second cameras 11, 12 corresponds to the view spanning the X2OY1 angle. The desired view may return to a view compatible to a view in a traditional right side mirror; it is toward the east, spanning the angle V1OU1. At this point, the key region may be again defined by the angle V1OU1.

In terms of the block diagram of FIG. 12, in all three positions 22, 23 and 24, the first processor and memory unit 20 may receive the view signals corresponding to the angle X2OY1. At the position 22, after the turn signal switch 70 is set to its ‘ON’ position, the first processor and memory unit 20 may communicate to the display interface unit 30 to use the V2OU2 angle as defining the key region. While at the position 23, the first processor and memory unit 20 may communicate to the display interface unit 30 to use the V3OU3 angle as defining the key region. Whereas, at the position 24, the first processor and memory unit 20 may communicate to the display interface unit 30 to use the V4OU4 angle as defining the key region.

Similar to Example 5 , in the Example 6 , the display interface unit 30 has an additional task when compared to Example 1 . The display interface unit 30 needs to handle situations when the key region does not entirely fall inside the view of one of the cameras. That is, the key region does not entirely fall inside the X1OY1 angle and it does not entirely fall inside the X2OY2 angle. For example, in FIG. 14, at the position 23, the key region angle U3OV3 does not fall inside X1OY1 or X2OY2. In this case, referring to FIG. 14 and the position 23, the display interface unit 30 needs to (1) find angle V3O5, corresponding to a portion of the key region which is inside X1OY1; (2) find angle SOU3, corresponding to the remaining portion of the key region inside X2OY2; (3) use the second processor and memory unit 40 to limit the view of the first camera 11 to the portion of the view encompassed by the angle V3O5; (4) use the second processor and memory unit 40 to limit the view of the second camera 12 to the portion of the view encompassed by the angle SOU3; and (5) stich the two limited views to form a limit view corresponding to the key region, angle V3OU3.

Above line OS is a ray inside X1OY2. OS can be fixed with respect to X1OY2 for all angular positions of the automobile 4, or it can vary from angular position to angular position, as long as it is inside X1OY2.

In general, the display interface unit 30 may use the second processor and memory unit 40 to limit the wide panorama view of the first and second cameras 11, 12 to the key region, VOU angle. If angle VOU entirely falls inside X1OY1, only the view of the first camera 11 can be used for this step. If angle VOU entirely falls inside X2OY2, only the view of the second camera 12 can be used for this step. Otherwise the above method can be used.

More specifically, referring to FIG. 14, the display interface unit 30 may use the second processor and memory unit 40 to limit the wide panorama view of the first and second cameras 11, 12 to the portion of the view encompassed by the angle V2OU2 at the position 22. Here, the key region entirely falls inside X2OY2, therefore only the view of the second camera 12 is used for this step.

The display interface unit 30 may use the second processor and memory unit 40 to limit the wide panorama view of the first and second cameras 11, 12 to the portion of the view encompassed by the angle V3OU3 at the position 23. Here, the key region does not entirely falls inside X1OY1 or X2OY2, therefore the above method is used for this step.

Finally, the display interface unit 30 may use the second processor and memory unit 40 to limit the wide panorama view of the first and second cameras 11, 12 to the portion of the view encompassed by the angle V4OU4 at the position 24. Here, the key region entirely falls inside X1OY1, therefore only the view of the first camera 11 is used for this step.

It should be noted that the key region position may change quickly from V1OU1 to V2OU2 in the position 22. Then, the key region position may be updated dynamically and gradually from V2OU2 to V3OU3 to V4OU4 as the automobile 4 is making the left turn. The updates may be such that while the wide panorama view of the first and second cameras 11, 12, the angle X2OY1, is turning during the left turn in a counter clockwise direction, the key region may be defined by an angle facing east at all times during the left turn.

Properties that are used by the first processor and memory unit 20 to update the position of the key region are as follows. Once a left turn signal is detected, the angular position of the automobile 4 derived from the angular sensor 60 may be stored in the memory part of the first processor and memory unit 20. Then, during the left turn, between successive readings of the angular sensor 60, the change in the angular position of the automobile 4 may be calculated by the first processor and memory unit 20. In response to a change of delta degrees, the first processor and memory unit 20 may update the position of the key region as follows: angle VcOUc is angle VpOUp rotated by -delta degrees, where VpOUp is the angle corresponding to the position of the previous key region, VcOUc is the angle corresponding to the position of the current key region.

Therefore, going back to FIG. 14, from the position 22 to position the 23, the automobile 4 may make a total of 45 degrees rotation in a counter clockwise direction. Hence the key region may be updated for a total of 45 degrees in a clockwise direction from the angle V2OU2 in the position 23 to the angle V3OU3 in the position 23.

Similarly, from the position 23 to the position 24, the automobile 4 may make another total of 45 degrees rotation in a counter clockwise direction. Hence the key region may be updated for another total of 45 degrees in a clockwise direction from the angle V3OU3 in the position 24 to the angle V4OU4 in the position 24.

Typically, all the updates may be made gradually making the view in the monitor 50 smooth.

### EXAMPLE 7

Example 7 is explained using FIGS. 12, 11, and 15. Example 7 uses the same block diagram, FIG. 12, as did Example 5 . Therefore, the earlier description of FIG. 12 still applies.

In this embodiment, more than one camera is used. More specifically, referring to FIG. 11, the monitor 50, and two cameras: the first camera 11 and the second camera 12, with respect to the automobile 4 are depicted. The first and second cameras 11, 12 may be configured together to capture a wide, panorama view containing a key region containing a desired view. Each camera may provide a portion of the wide panorama view. Typically these portions overlap to make “stitching” them easier.

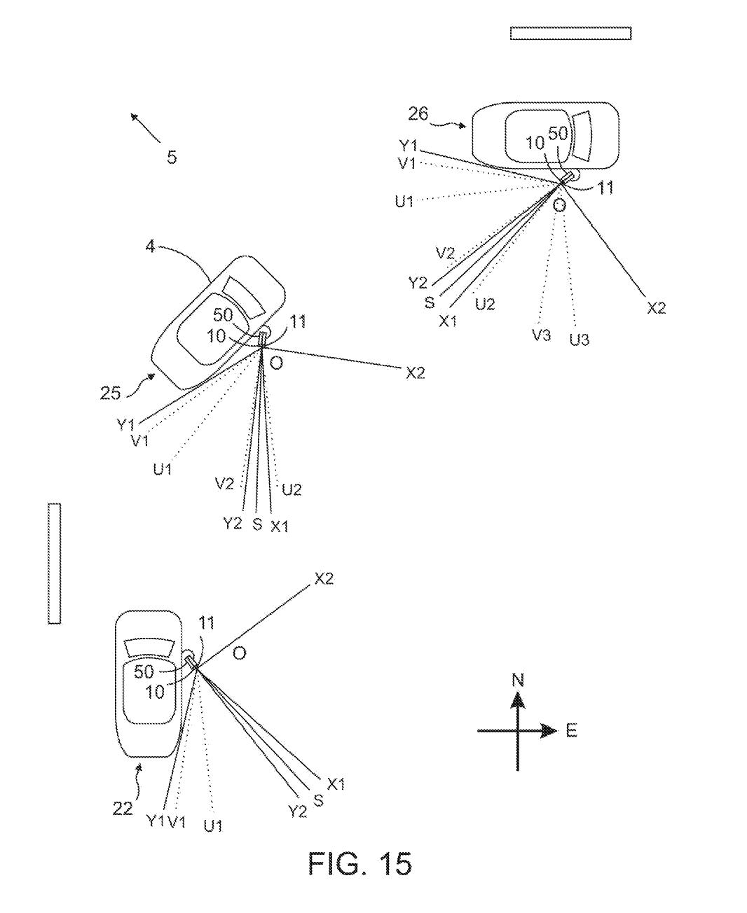

Example 7 applies to the right side monitor during right turns. In FIG. 15, the automobile 4, the monitor 50 and the first and second cameras 11, 12 are shown in the three positions 22, 25, and 26 of FIG.1.

At the position 22, facing north, before the turn signal switch 70 is set to its ‘ON’ position, the view signal of the first camera 11 corresponds to a view spanning X1OY1 angle, and the view signal of the second camera 12 corresponds to a view spanning X2OY2 angle; these views overlap over the X1OY2 angle. Further, the wide panorama view of the first and second cameras 11, 12 corresponds to a view spanning X2OY1 angle. The key region may be defined by an angle, V1OU1. The desired view may be compatible to the view of a traditional right side mirror.

When the turn signal switch 70 is set to its ‘ON’ position indicating a right turn (for Example 7 ), the desired view becomes a view of the road section immediately behind the vehicle on the right side before the turning is initiated. Until the right turn is completed, the desired view may stay the same, it faces south.

As the automobile 4 is turning right, the view in the monitor 50 may be of the road section facing south. At the end of the right turn, the view in the monitor 50 may return to a view compatible to the view of a traditional right side mirror.

More specifically, referring to FIG. 15, when the automobile 4 is in the position 25 having completed half of the right turn, the wide panorama view of the first and second cameras 11, 12 corresponds to a view spanning X2OY1 angle. Since the position of the first and second cameras 11, 12 are stationary with respect to the automobile 4, the views of the first and second cameras 11, 12 turn as the automobile 4 is turning. This explains why the X2OY1 angle that corresponds to the wide panorama view of the first and second cameras 11, 12 at the position 25 is a rotated version of the X2OY1 angle at the position 22.

At the position 25, the key region may be defined by an angle, V2OU2, and the desired view may be toward the south, spanning the angle V2OU2.

When the automobile 4 is in the position 26 just before the right turn is completed, the wide panorama view of the first and second cameras 11, 12 corresponds to the view spanning the X2OY1 angle. The key region may be defined by an angle, V3OU3, and the desired view may be toward the south, spanning an angle V3OU3.

Finally, when the automobile 4 is in the position 26 and after the right turn is completed, the wide panorama view of the first and second cameras 11, 12 corresponds to the view spanning the X2OY1 angle. The desired view may return to a view compatible to a view in a traditional right side mirror; it is toward the east, spanning the angle V1OU1. At this point, the key region may again be defined by the angle V1OU1.

In terms of the block diagram of FIG. 12, in all three positions: 22, 25 and 26, the first processor and memory unit 20 may receive the view signals corresponding to the angle X2OY1. At the position 22, the first processor and memory unit 20 may communicate to the display interface unit 30 to use the V1OU1 angle as defining the key region.

While at the position 25, the first processor and memory unit 20 may communicates to the display interface unit 30 to use the V2OU2 angle as defining the key region. Whereas at the position 26, the first processor and memory unit 20 may communicate to the display interface unit 30 to use the V3OU3 angle as defining the key region.

Similar to Example 5 , in Example 7 , the display interface unit 30 has an additional task when compare to Example 1 . The display interface unit 30 needs to handle situations when the key region does not entirely fall inside the view of one of the cameras. That is, the key region does not entirely fall inside the X1OY1 angle and it does not entirely fall inside the X2OY2 angle. For example, in FIG. 15, at the position 25, the key region angle U2OV2 does not fall inside X1OY1 or X2OY2. In this case, referring to FIG. 15 and the position 25, the display interface unit 30 needs to (1) find an angle V2O5, corresponding to a portion of the key region which is inside X1OY1; (2) find an angle SOU2, corresponding to the remaining portion of the key region inside X2OY2; (3) use the second processor and memory unit 40 to limit the view of the first camera 11 to the portion of the view encompassed by the angle V2O5; (4) use the second processor and memory unit 40 to limit the view of the second camera 12 to the portion of the view encompassed by the angle SOU2; and (5) stich the two limited views to form a limit view corresponding to the key region, angle V2OU2.

Above line OS is a ray inside X1OY2. OS can be fixed with respect to X1OY2 for all angular positions of the automobile 4, or it can vary from angular position to angular position, as long as it is inside X1OY2.

In general, the display interface unit 30 may use the second processor and memory unit 40 to limit the wide panorama view of the first and second cameras 11, 12 to the key region, VOU angle. If angle VOU entirely falls inside X1OY1, only the view of the first camera 11 can be used for this step. If angle VOU entirely falls inside X2OY2, only the view of the second camera 12 can be used for this step. Otherwise the above method can be used.

More specifically, referring to FIG. 15, the display interface unit 30 may use the second processor and memory unit 40 to limit the wide panorama view of the first and second cameras 11, 12 to the portion of the view encompassed by the angle V1OU1 at the position 22. Here the key region entirely falls inside X1OY1, therefore only the view of the first camera 11 is used for this step.

The display interface unit 30 may use the second processor and memory unit 40 to limit the wide panorama view of the first and second cameras 11, 12 to the portion of the view encompassed by the angle V2OU2 at the position 25. Here, the key region does not entirely falls inside X1OY1 or X2OY2, therefore the above method is used for this step.

Finally, the display interface unit 30 may use the second processor and memory unit 40 to limit the wide panorama view of the first and second cameras 11, 12 to the portion of the view encompassed by the angle V3OU3 at the position 26. Here the key region entirely falls inside X2OY2, therefore only the view of the second camera 12 is used for this step.

It should be noted that the key region position may be updated dynamically and gradually from V1OU1 to V2OU2 to V3OU3 as the automobile 4 is making the right turn. The updates may be such that while the wide panorama view of the first and second cameras 11, 12, the angle X2OY1 is turning during the right turn in a clockwise direction, the key region may be defined by an angle facing south at all times during the right turn.

Properties that are used by the first processor and memory unit 20 to update the position of the key region are as follows. Once a right turn signal is detected, the angular position of the automobile 4 derived from the angular sensor 60 may be stored in the memory part of the first processor and memory unit 20. Then, during the right turn, between successive readings of the angular sensor 60, the change in the angular position of the automobile 4 may be calculated by the first processor and memory unit 20. In response to a change of delta degrees, the first processor and memory unit 20 may update the position of the key region as follows: angle VcOUc is angle VpOUp rotated by -delta degrees, where VpOUp is the angle corresponding to the position of the previous key region, VcOUc is the angle corresponding to the position of the current key region, and -delta degrees rotation is in the opposite of delta degrees rotation.

Therefore, going back to FIG. 15, from the position 22 to the position 25, the automobile 4 may make a total of 45 degrees rotation in a clockwise direction. Hence the key region may be updated for a total of 45 degrees in a counter clockwise direction from the angle V1OU1 in the position 25 to the angle V2OU2 in the position 25.

Similarly, from the position 25 to the position 26, the automobile 4 may make another total of 45 degrees rotation in a clockwise direction. Hence the key region may be updated for another total of 45 degrees in a counter clockwise direction from the angle V2OU2 in the position 26 to the angle V3OU3 in the position 26.

Typically, all the updates may be made gradually, making the view in the monitor 50 smooth.

### EXAMPLE 8

Example 8 is explained using FIGS. 12, 10, and 16. Example 8 uses the same block diagram, FIG. 12, as did Example 5 . Therefore, the earlier description of FIG. 12 still applies.

In this example, more than one camera is used. More specifically, referring to FIG. 10, the monitor 50, and two cameras, the first camera 11 and the second camera 12, with respect to the automobile 4 are depicted. The first and second cameras 11, 12 may be configured together to capture a wide, panorama view containing a key region containing a desired view. Each camera may provide a portion of the wide panorama view. Typically these portions overlap to make “stitching” them easier.

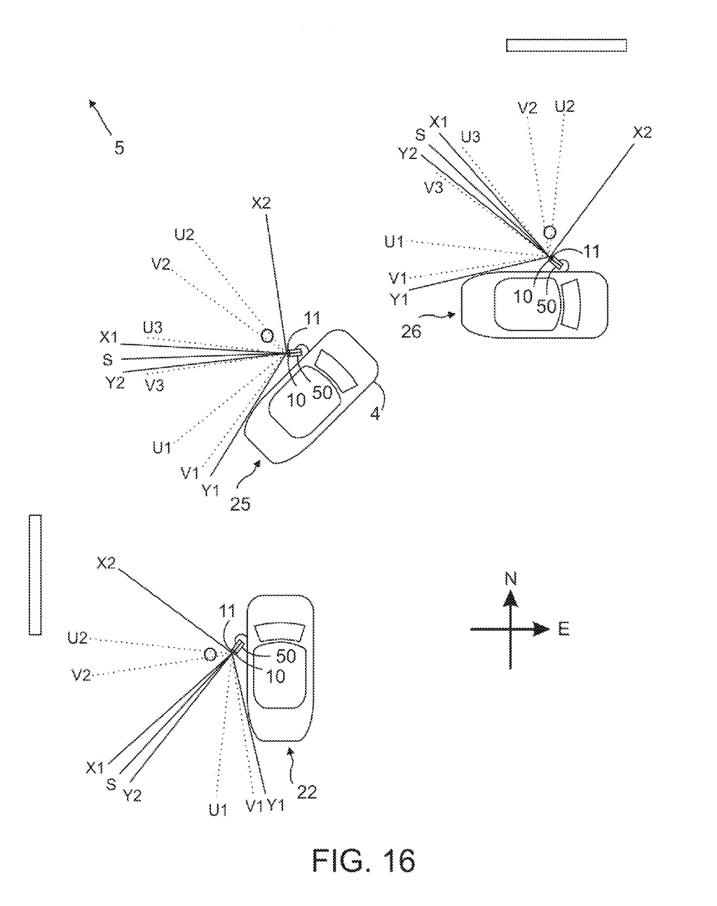

Example 8 applies to the left side monitor during right turns. In FIG. 16, the automobile 4, the monitor 50 and the cameras 11 and 12 are shown in the three positions 22, 25, and 26 of FIG.1.

At the position 22, facing north, before the turn signal switch 70 is set to its ‘ON’ position, the view signal of the first camera 11 corresponds to a view spanning X1OY1 angle, and the view signal of the second camera 12 corresponds to a view spanning X2OY2 angle; these views overlap over X1OY2 angle. Further, the wide panorama view of the first and second cameras 11, 12 corresponds to a view spanning X2OY1 angle. The key region may be defined by an angle, V1OU1. The desired view may be compatible to the view of a traditional left side mirror.

When the turn signal switch 70 is set to its ‘ON’ position indicating right turn (for example 8 ), the desired view may change quickly to a view of a road section opposite to that of the road section into which the vehicle is turning. The key region may change from being defined by an angle, V1OU1 to being defined by an angle V2OU2 at the position 22 of FIG. 16. The angle V2OU2 is obtained by rotating the angle V1OU1 by a predetermined angle, alpha. Alpha may be equal to 90 degrees clockwise. Until the right turn is completed, the desired view stays the same, it faces west.

As the automobile 4 is turning right, the view in the monitor 50 may be of the road section facing west. At the end of the right turn, the view in the monitor 50 may return to a view compatible to the view of a traditional left side mirror.

More specifically, referring to FIG. 16, when the automobile 4 is in the position 25 having completed half of the right turn, the wide panorama view of the first and second cameras 11, 12 corresponds to a view spanning X2OY1 angle. Since the position of the first and second cameras 11, 12 are stationary with respect to the automobile 4, the views of the first and second cameras 11, 12 turn as the automobile 4 is turning. This explains why the X2OY1 angle that corresponds to the wide panorama view of the first and second cameras 11, 12 at the position 25 is a rotated version of the X2OY1 angle at the position 22.

At the position 25, the key region may be defined by an angle, V3OU3, and the desired view may be toward the west, spanning the angle V3OU3.

When the automobile 4 is in the position 26 just before the right turn is completed, the wide panorama view of the first and second cameras 11, 12 corresponds to the view spanning the X2OY1 angle. The key region may be defined by an angle, V4OU4, and the desired view may be toward the west, spanning an angle V4OU4.

Finally, when the automobile 4 is in the position 26 and after the right turn is completed, the wide panorama view of the first and second cameras 11, 12 corresponds to the view spanning the X2OY1 angle. The desired view may return to a view compatible to a view in a traditional left side mirror; it is toward the west, spanning the angle V1OU1. At this point, the key region may again be defined by the angle V1OU1.

In terms of the block diagram of FIG. 12, in all three positions: 22, 25 and 26, the first processor and memory unit 20 may receive the view signals corresponding to the angle X2OY1. At the position 22, after the turn signal switch 70 is set to its ‘ON’ position, the first processor and memory unit 20 may communicate to the display interface unit 30 to use the V2OU2 angle as defining the key region. While at the position 25, the first processor and memory unit 20 may communicate to the display interface unit 30 to use the V3OU3 angle as defining the key region. Whereas at the position 26, the first processor and memory unit 20 may communicate to the display interface unit 30 to use the V4OU4 angle as defining the key region.

Similar to Example 5 , in Example 8 , the display interface unit 30 has an additional task when compare to Example 1 . The display interface unit 30 needs to handle situations when the key region does not entirely fall inside the view of one of the cameras. That is, the key region does not entirely fall inside X1OY1 angle and it does not entirely fall inside X2OY2 angle. For example, in FIG. 16, at the position 25, the key region angle U3OV3 does not fall inside X1OY1 or X2OY2. In this case, referring to FIG. 16 and the position 25, the display interface unit 30 needs to (1) find an angle V3O5, corresponding to a portion of the key region which is inside X1OY1; (2) find an angle SOU3, corresponding to the remaining portion of the key region inside X2OY2; (3) use the second processor and memory unit 40 to limit the view of the first camera 11 to the portion of the view encompassed by the angle V3O5; (4) use the second processor and memory unit 40 to limit the view of the second camera 12 to the portion of the view encompassed by the angle SOU3; and (5) stich the two limited views to form a limit view corresponding to the key region, angle V3OU3.

Above line OS is a ray inside X1OY2. OS can be fixed with respect to X1OY2 for all angular positions of the automobile 4, or it can vary from angular position to angular position, as long as it is inside X1OY2.

In general, the display interface unit 30 may use the second processor and memory unit 40 to limit the wide panorama view of the first and second cameras 11, 12 to the key region VOU angle. If the angle VOU entirely falls inside X1OY1, only the view of the first camera 11 can be used for this step. If the angle VOU entirely falls inside X2OY2, only the view of the second camera 12 can be used for this step. Otherwise the above method can be used.

More specifically, referring to FIG. 16, the display interface unit 30 may use the second processor and memory unit 40 to limit the wide panorama view of the first and second cameras 11, 12 to the portion of the view encompassed by the angle V2OU2 at the position 22. Here, the key region entirely falls inside X2OY2, therefore only the view of the second camera 12 is used for this step.

The display interface unit 30 may use the second processor and memory unit 40 to limit the wide panorama view of the first and second cameras 11, 12 to the portion of the view encompassed by the angle V3OU3 at the position 25. Here, the key region does not entirely falls inside X1OY1 or X2OY2, therefore the above method is used for this step.

Finally, the display interface unit 30 may use the second processor and memory unit 40 to limit the wide panorama view of the cameras 11 and 12 to the portion of the view encompassed by the angle V4OU4 at the position 26. Here, the key region entirely falls inside X1OY1, therefore only the view of the camera 11 is used for this step.

It should be noted that the key region position may change quickly from V1OU1 to V2OU2 in the position 22. Then the key region position may be updated dynamically and gradually from V2OU2 to V3OU3 to V4OU4 as the automobile 4 is making the right turn. The updates may be such that while the wide panorama view of the first and second cameras 11, 12, the angle X2OY1, is turning during the right turn in a clockwise direction, the key region may be defined by an angle facing west at all times during the right turn.

Properties that are used by the first processor and memory unit 20 to update the position of the key region are as follows. Once a right turn signal is detected, the angular position of the automobile 4 derived from the angular sensor 60 may be stored in the memory part of the first processor and memory unit 20. Then, during the right turn, between successive readings of the angular sensor 60, the change in the angular position of the automobile 4 may be calculated by the first processor and memory unit 20. In response to a change of delta degrees, the first processor and memory unit 20 may update the position of the key region as follows: angle VcOUc is angle VpOUp rotated by -delta degrees, where VpOUp is the angle corresponding to the position of the previous key region, VcOUc is the angle corresponding to the position of the current key region.

Therefore, going back to FIG. 16, from the position 22 to position the 25, the automobile 4 may make a total of 45 degrees rotation in a clockwise direction. Hence the key region may be updated for a total of 45 degrees in a counter clockwise direction from the angle V2OU2 in the position 25 to the angle V3OU3 in the position 25.

Similarly, from the position 25 to the position 26, the automobile 4 may make another total of 45 degrees rotation in clockwise direction. Hence the key region may be updated for another total of 45 degrees in counter clockwise direction from the angle V3OU3 in the position 26 to the angle V4OU4 in the position 26.

Typically, all the updates may be made gradually, making the view in the monitor 50 smooth.

In Examples 2 and 6, setting alpha to be equal to 90 degrees works well if the streets in the intersection 5 are roughly perpendicular to each other. Referring to FIG. 1, if angle beta is smaller or larger than 90, then the updated positions of the key region will be off by the absolute value of alpha-beta. In general, alpha should be equal to beta for Example 2 and 6. A Global Positioning System (GPS) may be used to provide GPS signals to the first processor and memory unit. The first processor and memory unit may calculate an estimate of beta based on the GPS information. Further the first processor and memory unit may use alpha=beta in the operation of the dynamically adjusting surveillance system. In addition, in one application, the GPS may be used to compute beta as above, then the first processor and memory unit 20 may monitor the overall angular change of the automobile 4 from the start of the turn. Once the overall angular change is close to beta degrees, then the first processor and memory unit 20 terminates the dynamically adjusting surveillance system since that situation will place the automobile 4 in the general direction of the intersecting street.

In Examples 4 and 8, setting alpha to be equal to 90 degrees works well if the streets in the intersection 5 are roughly perpendicular to each other. Referring to FIG. 1, if angle beta is smaller or larger than 90, then the updated positions of the key region will be off by the absolute value of alpha-beta. In general, alpha should be equal to 180-beta for Examples 4 and 8. A Global Positioning System (GPS) may be used to provide GPS signals to the first processor and memory unit. The first processor and memory unit may calculate an estimate of beta based on the GPS information. Further the first processor and memory unit may use alpha=180-beta in the operation of the dynamically adjusting surveillance system. In addition, in one application, the GPS may be used to compute beta as above, then the first processor and memory unit 20 may monitor the overall angular change of the automobile 4 from the start of the turn. Once the overall angular change is close to 180-beta degrees, then the first processor and memory unit 20 terminates the dynamically adjusting surveillance system since that situation will place the automobile in the general direction of the intersecting street.

The GPS may also be used to determine whether the dynamically adjusting surveillance system may be activated or may be in a stand-by mode (where the view in monitor 50 is similar to a conventional mirror). For example, if a user is using their turn signal for a lane change, the view in the monitors may or may not need to change. The signal from the GPS may be used to recognize when a street is present to indicate that the user intends to make a turn. Moreover, the dynamically adjusting surveillance system may interact with a speed indicator of the vehicle (or a speed indicator on a GPS) to also help determine whether the user intends to make a turn or is using the turn signal for some other function.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. A dynamically adjusting surveillance system comprising:
at least one camera configured to capture a view containing a key region that encompasses a desired view;
a monitor;
a display interface unit configured to display the key region in the view of the at least one camera on the monitor;
an angular sensor configured to detect an orientation of a vehicle, the angular sensor providing an angular position signal;
a first processor and memory unit communicating with the angular sensor and with a turn signal switch of the vehicle, the first processor and memory unit receiving the angular position signal and a turn indication signal from the turn signal switch, the first processor and memory unit updating the key region based on the angular position signal and the turn indication signal, the first processor and memory unit providing the updated key region to the display interface unit;
wherein the display interface unit displays the updated key region in the view of the monitor.

2. The dynamically adjusting surveillance system of claim 1, wherein the desired view comprises a view of a road section immediately behind the vehicle before a turn is initiated.

3. The dynamically adjusting surveillance system of claim 1, wherein the desired view comprises a view of a road section opposite to that of a road section into which the vehicle is turning.

4. The dynamically adjusting surveillance system of claim 1, wherein the at least one camera has a wide angle lens.

5. The dynamically adjusting surveillance system of claim 1, further comprising a Global Positioning System (GPS) providing GPS signals to the first processor and memory unit, wherein the first processor and memory unit is further configured to calculate the updated position of the key regions based on the GPS signals.

6. The dynamically adjusting surveillance system of claim 1, further comprising a Global Positioning System (GPS) providing GPS signals to the first processor and memory unit, wherein the first processor and memory unit is further configured to terminate the dynamically adjusting surveillance system based on the GPS signals.

7. The dynamically adjusting surveillance system of claim 1, wherein the one or more cameras is a single camera for each monitor.

8. The dynamically adjusting surveillance system of claim 1, wherein the one or more cameras include two or more cameras for each monitor.

9. The dynamically adjusting surveillance system of claim 1, wherein the updated key region is continually displayed on the monitor to provide a smooth and gradual transition between each successive one of the updated key regions.

10. The dynamically adjusting surveillance system of claim 1, wherein the monitor includes a left side monitor and a right side monitor, where each of the left side monitor and the right side monitor includes the camera.

11. A dynamically adjusting surveillance system comprising:
a first camera and a second camera configured together to capture a wide, panorama view containing a key region that encompasses a desired view;
a monitor;
a display interface unit configured to display the key region in the wide, panorama view of the first and second cameras on the monitor;
an angular sensor configured to detect an orientation of a vehicle, the angular sensor providing an angular position signal; and
a first processor and memory unit communicating with the angular sensor and with a turn signal switch of the vehicle, the first processor and memory unit receiving the angular position signal and a turn indication signal from the turn signal switch, the first processor and memory unit updating the key region based on the angular position signal and the turn indication signal, the first processor and memory unit providing the updated key region to the display interface unit;
wherein the display interface unit displays the updated key region in the monitor.

12. The dynamically adjusting surveillance system of claim 11, wherein the desired view comprises a view of a road section immediately behind the vehicle before a turn is initiated.

13. The dynamically adjusting surveillance system of claim 11, wherein the desired view comprises a view of a road section opposite to that of the road section into which the vehicle is turning.

14. The dynamically adjusting surveillance system of claim 11, further comprising a Global Positioning System (GPS) providing GPS signals to the first processor and memory unit, wherein the first processor and memory unit is further configured to calculate the updated key regions based on the GPS signals.

15. The dynamically adjusting surveillance system of claim 11, further comprising a Global Positioning System (GPS) providing GPS signals to the first processor and memory unit, wherein the first processor and memory unit is further configured to terminate the system based on the GPS signals.

16. The dynamically adjusting surveillance system of claim 11, wherein the monitor includes a left side monitor and a right side monitor, each of the left side monitor and the right side monitor including the first camera and the second camera.

17. The dynamically adjusting surveillance system of claim 11, wherein the updated key region is continually displayed on the monitor to provide a smooth and gradual transition between each successive one of the updated key regions.
